(19) United States
(12) Patent Application Publication
(10) Pub. No.: US 2007/0002777 A1
(43) Pub. Date: Jan. 4, 2007

(54) Video-communication interface

(75) Inventors: Stuart Morris, South Plainfield, NJ (US); John M. Vitale, Monroe Twp., NJ (US); Michael E. Coker, Metuchen, NJ (US)

Correspondence Address: MORRISON & FOERSTER LLP, 1650 TYSONS BOULEVARD, SUITE 300, MCLEAN, VA, 22102, US

(73) Assignee: Glowpoint, Inc., Hillside, NJ (US)

(21) Appl. No.: 11/442,614

(22) Filed: May 30, 2006

Related U.S. Application Data
(60) Provisional application No. 60/685,375, filed on May 31, 2005.

(51) Int. Cl. H04L 12/16

(52) U.S. Cl. 370/260

(57) ABSTRACT

A videocommunication system and method, having an originating endpoint; and a recipient endpoint; wherein the originating endpoint is used to initiate a packet-based video-communication with the recipient endpoint; and wherein the originating endpoint comprises an interface to initiate a video communication with a live operator.

### REFERENCE TO RELATED APPLICATION

This application claims priority to U.S. Provisional Application No. 60/685,375, filed May 31, 2005, the contents of which are hereby incorporated by reference.

### FIELD OF THE INVENTION

The invention related to the field of video-communication.

### BACKGROUND

As described in co-pending U.S. patent application Ser. No. 10/990,351 titled Systems and Methods for an Operator System Service, which is herein incorporated by reference for all that it discloses and teaches, there are several benefits to a user from the assistance of a live video operator in a packet-switched videoconferencing system. For example, a live operator can provide services such as gateway assistance whereby the operator can transfer the originating video or audio caller to any other terminating video or audio device. The terminating device can be an on-net H.323 or SIP terminating device as part of the GlowPoint packet switched network, an off-net H.323 or SIP terminating device on the public Internet, or an ISDN H.320 device on the Public Switched Telephone Network (PSTN). In addition, the video operator can provide directory assistance, assistance to the deaf or hearing impaired, simple troubleshooting, conferencing services information, and general information about the conferencing service provider.

As described in co-pending U.S. Patent Application No. 60/616,638 titled Video Call Director (VCD), which is herein incorporated by reference for all that it discloses and teaches, there are several benefits to a user from the video mail in a packet-switched videoconferencing system. For example, the video mailbox can provide a subscriber with a personal video mailbox, similar to current voicemail services, which would answer a caller when the intended recipient either chose not to answer or was not available to answer the call. The caller would then be greeted by either a personally recorded video message greeting from the owner of the mailbox or a system generated default greeting stating the owner is unavailable and requesting the caller leave a message. The caller would then be prompted to record a message. Once the message is saved, the mailbox owner can receive a notification of the new message in their mailbox by an indicator such as a light. In addition, an email message is also generated to the mailbox owner. The mailbox owner can then retrieve and playback the message via either method.

### SUMMARY OF THE INVENTION

In order to enhance a user experience and to facilitate use of a videoconferencing system by less technical users, an aspect of the invention involves a system and method of initiating a live video operator session. In various embodiments of the invention, an interface is provided to initiate the live operator session. Furthermore, various embodiments of the invention may include a method and system for initiating other services, including, but not limited to: video mail; a contacts list, where calls may be generated either to one or multiple entries in the contact list based on a control such as a point and click with a standard PC mouse; previously called numbers; a redial function; or a privacy function that suspends a current videoconference. In yet further embodiments of the invention, an interface is provided to allow activation of these and other commands by using a single touch or click.

The embodiments described below further enhance the user experience by simplifying access to the live video operator and other functions made available through the interface. These enhancements can be provided, either fully or partially, through a software client executing on a personal computer as well as on embedded or dedicated systems.

### BRIEF DESCRIPTION OF THE DRAWINGS

FIG. 1 depicts an exemplary embodiment of an interface according to an aspect of the invention

FIG. 2 depicts a system diagram of an exemplary embodiment of the invention.

FIG. 3 depicts an exemplary embodiment of a packet based videoconferencing protocol according to an aspect of the invention.

FIG. 4 depicts a system for transmitting data using an H.323 protocol.

FIG. 5 depicts an exemplary embodiment of a communications network according to an aspect of the invention.

### DETAILED DESCRIPTION

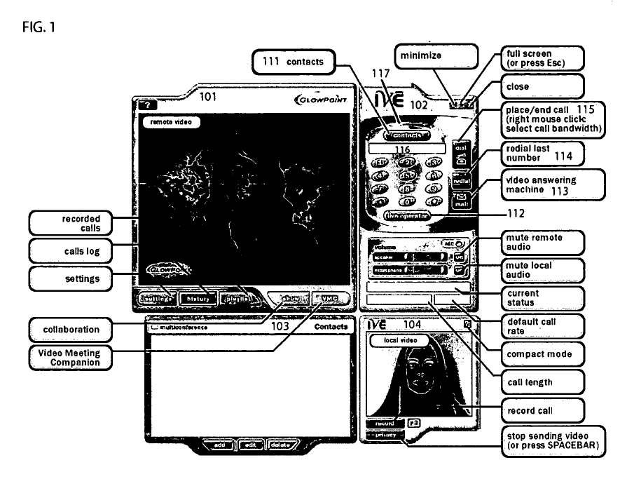

Given the high value of live video operator and video mail services, a user experience can be enhanced by improving the ease of use of these services. An exemplary embodiment of an interface for a videoconferencing client with an improved interface is shown in FIG. 1. As shown in FIG. 1, the user interface can comprise a plurality of panes or panels, each further comprising user interface elements for performing certain functions. As shown in the example of FIG. 1, pane 101 can be configured to comprise a remote video display. Pane 102 can be configured to comprise a dial pad 117 and additional buttons for access to enhanced functions. Pane 104 can be configured to comprise a local video display. Pane 103 can be configured to comprise contacts 111 and other functionality. Other variations are possible without departing from the scope of this disclosure.

The exemplary interface shown in FIG. 1 is presented in four panes 101, 102, 103, and 104. As shown in FIG. 1, live operator button 112 can be placed proximately to the “0” key in dial pad 117 of pane 102. Similarly, contacts button 111 can be placed proximately to user entry field 116. The placement of functional buttons near other contextually related buttons or functional areas further improves the ease of use of the interface. While one exemplary embodiment is shown in FIG. 1, other embodiments in which buttons are placed in other arrangements are also possible. For example, the dial pad of pane 102 can be relocated to other panes as appropriate.

While the systems and methods described herein are directed to a simplified interface for a videoconferencing system, as shown in FIG. 1, the systems and methods described herein may also provide simplified access to commonly accessed features such as a live operator 112, contacts 111, video mail 113, dial 115, and redial 114. While the description below is made with reference to the live operator button 112, one of ordinary skill in the art would recognize that the teachings below are equally applicable to the contacts 111, video mail 113, dial 115, and redial 114 functions as well as other video call center functionality.

One of ordinary skill in the art would also recognize that the systems and methods disclosed herein may also be applied to audio conferencing and other conferencing systems.

According to the embodiments described below, a user of the videoconferencing client is not required to know the extension number for accessing the live operator or video call center. Rather, the user need only invoke a designated button on the interface, press a predetermined key or combination of keys, speak the word “operator”, or otherwise indicate the selection of the live operator option. As described below, various input methods can be used to access the live operator. One skilled in the art will recognize that once the user has invoked the live operator, the establishment of a communication session with the operator may be accomplished though the use of any one of various systems and methods for videoconferencing.

In various embodiments, once a session with an operator is established, the session may be in one or more of a plurality of formats. For example, in one format, the operator may be viewable to only the user that indicated a need for the operator. In another embodiment, two or more users may be able to view and/or hear the operator. In some embodiments, the user who requests the operator may designate which users have access to the operator. In other embodiments, the operator may decide who has access. In yet further embodiments, both the user and the operator can control access. In other embodiments, users who do not indicate a need for an operator may limit access an operator may have to information and/or data coming from that user. Such a feature may enhance the privacy and/or security of the user.

In some embodiments of the invention, the interface may automatically determine the connection speed at which the operator session is conducted. In other embodiments, the connection speed may be manually set by either the user or the operator.

In some embodiments, the interface can include a button 112 for access to a live operator. Activation of the live operator button 112 can initiate a call to a live operator via video. In some such embodiments, a single click may be used to activate the live operator button 112. In such embodiments, an exemplary input method acceptable for use with this invention is to recognize a single click of a mouse button while a mouse pointer is hovering over the live operator button 112. For example, a user may move a mouse pointer on to the live operator button 112 and click a mouse button. Such an input may cause the videoconferencing client to invoke a communication session with a live operator.

In further embodiments, additional steps or actions may be performed after selection of the live operator button. In some such embodiments, an initial click may be followed by other selections such as choosing options, confirming choices, etc. The user may select the live operator 112 button with a single click of the left mouse button for example, and then be presented with a drop down menu or dialog box including the options of making further configuration and establishing a videoconferencing session at that time.

In other embodiments, a double click may be used. A double click may be two single clicks which occur within a set number of seconds of each other. The length of time between two clicks can be set by the user or administrator using the conventional mouse program already installed on the computer.

In still further embodiments, the live operator may be activated by one or more keystrokes made in combination or separately. In some embodiments, voice activation can be used to recognize a spoken word such as “operator” and thereby invoke the live operator service. One of ordinary skill in the art will recognize that various other input methods can be used to invoke the operator.

In still further embodiments, the live operator may be activated by using a remote control device. Such a remote control device may be activated using a single button or a combination of buttons.

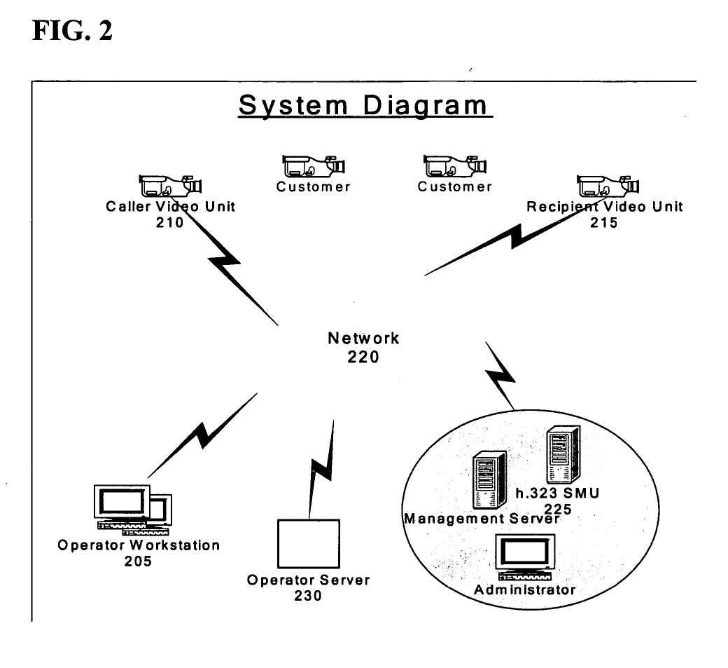

FIG. 2 depicts a system diagram of an exemplary embodiment of the invention. As shown in FIG. 2, a videoconferencing system may be made of: a caller video unit 210, which may also be an originating endpoint; a recipient video unit 215, which may also be a recipient endpoint; an operator workstation 205; an operator server 230; a network 220, and a management server. In an embodiment of the depicted system, the caller video unit 210 may attempt to establish a videoconference with the recipient video unit 215 over the network 220. If the caller video unit 210 has difficulty making the connection, for technical and/or other reasons, such as forgetting a videoconference number or IP address, the user may initiate a live operator session with an operator at an operator workstation 205. The operator workstation 205 may also be connected to the network 220 through the operator server 230. The operator may then use additional capabilities provided by the operator workstation 205, the operator server 230 and/or another resource to assist the user in making or allowing the desired connection. An operator session may also be initiated to assist a caller or a recipient with a currently established connection. An operator session may also be initiated for any number of other purposes associated with videoconferencing.

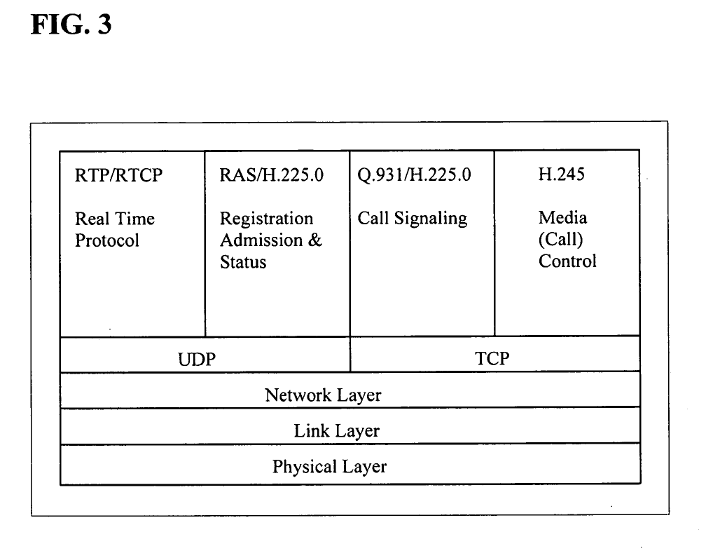

FIG. 3 depicts an exemplary embodiment of a packet based videoconferencing protocol according to an aspect of the invention. ITU-T H.323 is one example of such a multimedia conferencing protocol and is shown in FIG. 3. The H.323 protocol allows voice, video, and data conferencing over packet-switched networks. The H.323 protocol is a framework that describes how various components interact. As shown in FIG. 3, H.323 is an umbrella ITU-T standard under which H.225.0 defines the call signaling and communication between video and voice endpoints and a gatekeeper. Additionally, H.245 is used to negotiate audio and video capabilities and to control aspects of the conference between two or more multimedia endpoints.

In the H.323 framework, the originating calling party endpoint determines call capabilities, including bandwidth and coder/decoders (CODECS). For example, a call can be established using protocols including but not limited to H.261, H.263, or H.264 video and G.728 audio for low bandwidth calls, or G.722 audio for high bandwidth calls. G.711 audio is also supported by H.323 for legacy-type video endpoints as well as audio only endpoints.

The present invention can be configured to use existing and approved multimedia standards including, but not limited to, H.323, H.225, H.245, RTP/RTCP. The present invention can also be configured to use the Simple Network Management Protocol (SNMP) for system management functions. The systems and methods of the invention can utilize typical LAN multimedia devices such as H.323 gatekeepers, server hardware running the Microsoft Windows™ server operating system, PC workstations with internet browsers, and H.323 compliant videoconferencing systems. While the embodiments described below are described with reference to H.323 compliant systems, one skilled in the art would recognize that other protocols, such as Session Initiated Protocol (SIP), as well as audio, video and data conferencing standards could be used without departing from the scope of the invention.

An embodiment of an Operator System (OS) of the present invention may be configured as a client-server software-based solution that can queue and route H.323 (IP) or H.320 (ISDN via a H.320-H.323 gateway) video calls to a live video operator. The OS of the present invention can perform functions similar to those of a typical call center and can include Automatic Call Distributor (ACD) functionality which can queue and forward video and/or voice calls. Because the OS can be configured in client-server architecture, the person performing the live operator function can be at any geographic location as long as the location has access to the Internet and an H.323 standards based videoconferencing system. The operator, wherever located, can assist callers by providing number information accessed though a database link to a standard SQL database and can provide technical assistance or any other information that a live operator could access and present to a caller through audio or video means. In addition, as described in more detail below, the operator can transfer the originating caller to any endpoint on the network or off the network including, but not limited to, an ISDN endpoint via an H.323/H.320 gateway or SIP client via a H.323/SIP gateway.

The OS can also combine multimedia standards based devices to proxy multimedia calls from end-users with H.323 based videoconferencing CODECs through a server-based system.

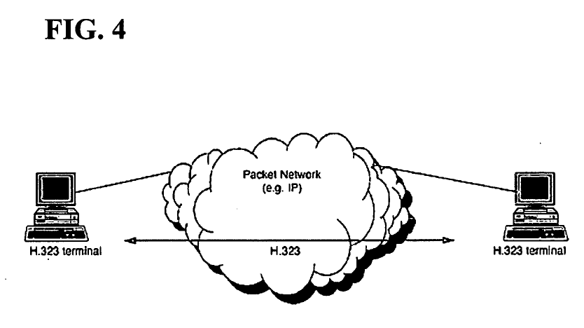

In various embodiments of the invention, an H.323 standard is used. The H.323 standard is a cornerstone technology for the transmission of real-time audio, video, and data communications over packet-based networks. It specifies the components, protocols, and procedures providing multimedia communication over packet-based networks as shown in FIG. 4. Packet-based networks may include IP-based (including the Internet) or Internet packet exchange (IPX) based local-area networks (LANs), enterprise networks (ENs), metropolitan-area networks (MANs), and wide-area networks (WANs). H.323 may be applied in a variety of mechanisms such as, but not limited to, audio only (IP telephony); audio and video (videotelephony); audio and data; and audio, video and data. H.323 may also be applied to multipoint-multimedia communications. H.323 provides myriad services and, therefore, can be applied in a wide variety of areas, such as, but not limited to, consumer, business, and entertainment applications.

The H.323 standard is specified by the ITU-T Study Group 16. Version 1 of the H.323 recommendation, visual telephone systems and equipment for LANs that provide a non-guaranteed quality of service (QoS), was accepted in October 1996. It was, as the name suggests, heavily weighted towards multimedia communications in a LAN environment. Version 1 of the H.323 standard does not provide guaranteed QoS.

The emergence of voice-over-IP (VoIP) applications and IP telephony has paved the way for a revision of the H.323 specification. The absence of a standard for voice over IP resulted in products that were incompatible. With the development of VoIP, new requirements emerged, such as providing communication between a PC-based phone and a phone on a traditional switched circuit network (SCN). Such requirements led to a standard for IP telephony. Version 2 of H.323, packet-based multimedia communications systems, was defined to accommodate these additional requirements and was accepted in January 1998. An embodiment of the invention as well as most modem video and audio codecs utilize Version 4 of H.323.

The H.320 series governs basic videotelephony concepts of audio, video and graphical communications by specifying requirements for processing audio and video information, providing common formats for compatible audio/video inputs and outputs, and protocols that allow a multimedia terminal to utilize the communications links and synchronization of audio and video signals.

Like the other multimedia teleconferencing standards, H.320 applies to multipoint and point-to-point sessions. The H.320 suite addresses videoconferencing over circuit switched services like ISDN or Switched-56 as well as dedicated services such as T1.

The H.320 protocol defines how real-time multimedia communications and conferencing are handled over various compatible switched or dedicated ISDN telecommunication links. The protocol is an international standard of the International Telecommunications Union (ITU), and it was adopted in 1990. Multimedia refers to the fact that the standard covers voice, video, and data. The standard is an umbrella standard and includes many other protocols that describe, as an example, how to encode and decode voice and data, how to setup calls between terminals, and how to handle data connections.

According to an aspect of the invention, an H.320 compliant terminal may have a microphone, a speaker system, a display, a camera, an ISDN connection to a public telephone network, and electronics to implement the H.320 protocols. Furthermore, a similar terminal may exist at a remote site. If local user dials an ISDN telephone number of the remote terminal, the H.320 protocols handle the call setup between the terminals. The local terminals microphone and camera can pick up audio and video from the local user, decode and compress the audio/video stream, and send it to the remote site all using the protocols as defined in the H.320 standard. The digital stream transmitted via the ISDN telecommunication lines to the remote site is then uncompressed, decoded, displayed and observed by the remote user. A similar audio/video stream may be formed at the remote site and sent to the local site where the audio and video from the remote site can be heard and seen by the local user. A fully interactive videoconference may thus be held between the two sites.

Further aspects of the invention utilize Session Initiation Protocol (SIP), which is an Internet Engineering Task Force (IETF) standard protocol for initiating an interactive user session that involves multimedia elements such as video, voice, chat, gaming, and virtual reality.

Like HTTP or SMTP, SIP works in the Application layer of the Open Systems Interconnection (OSI) communications model. The Application layer is the level responsible for ensuring that communication is possible. SIP can establish multimedia sessions or Internet telephony calls, and modify and/or terminate them. The protocol can also invite participants to unicast or multicast sessions that do not necessarily involve the initiator. Because SIP supports name mapping and redirection services, it makes it possible for users to initiate and receive communications and services from any location, and for networks to identify the users wherever they are.

SIP is a request-response protocol, dealing with requests from clients and responses from servers. Participants are identified by SIP URLs. Requests can be sent through other transport protocols, such as UDP, SCTP, or TCP. SIP determines the end system to be used for the session, the communication media and media parameters, and the called party's desire to engage in the communication. Once these are assured, SIP establishes call parameters at either end of the communication, and handles call transfer and termination.

Further embodiments of the invention may use an interface similar to that previously described to access a video mail system. In various aspects of the invention, the video mail system may be a real time mail system where a user is able to leave a real-time video mail to an intended recipient when the recipient does not complete a video-communication. In various aspects of the invention, the video-mails may be accessed through an interface. In various aspects of the invention, the interface may be activated in various ways, including, but not limited to: a single click using a mouse or another device, multiple clicks, a remote control, a user's voice, and/or a touch screen.

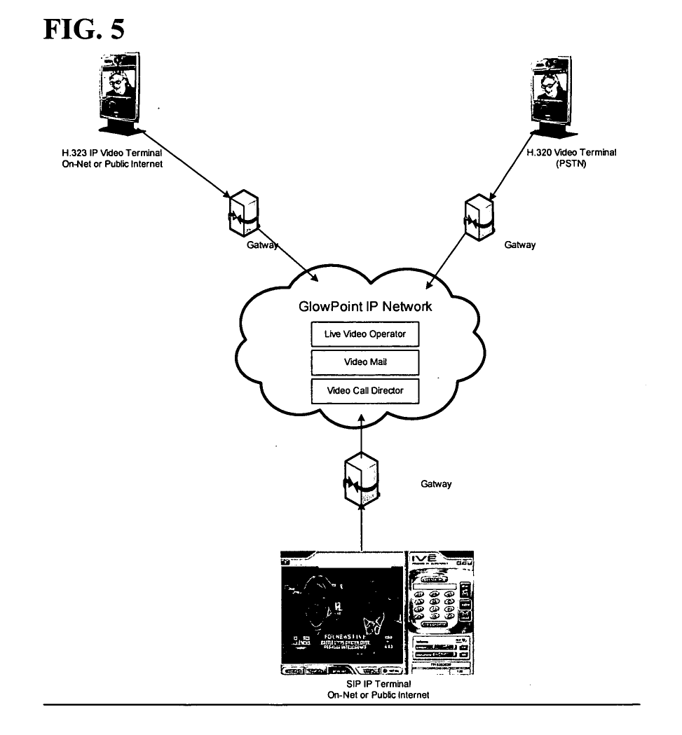

FIG. 5 depicts an exemplary embodiment of a communications network according to an aspect of the invention. FIG. 5 demonstrates the interoperability of an embodiment of the invention in which end users can communicate with a live video operator, a video mail application, and/or a video call director from any of several ITU-T standards based video and/or audio terminals. As shown in FIG. 5, terminals H.323, H.320 and SIP (named according to the respective protocols being used) communicate with each other through a single network which they access via respective gateways. While only three different protocols are shown, one of ordinary skill in the art would recognize that the system depicted is not limited by the choice of protocols used.

1. A videocommunication system, comprising:
an originating endpoint; and
a recipient endpoint;
wherein the originating endpoint is used to initiate a packet-based video-communication with the recipient endpoint; and
wherein the originating endpoint comprises an interface to initiate a video communication with a live operator.

2. The system of claim 1, further comprising a gateway through which data is transferred between the originating endpoint and the recipient endpoint.

3. The system of claim 1, wherein a SIP protocol is used.

4. The system of claim 1, wherein an H.323 protocol is used.

5. The system of claim 1, wherein an H.320 protocol is used.

6. The system of claim 1, wherein the endpoints use different video packet protocols.

7. The system of claim 1, wherein the endpoints use identical video packet protocols.

8. The system of claim 1, wherein the live operator uses a different protocol than at least one of the recipients.

9. The system of claim 1, wherein the communication with the live operator is a real time communication.

10. The system of claim 1, wherein the interface comprises a virtual button to initiate the communication with the live operator.

11. The system of claim 10, wherein the virtual button initiates the communication with the live operator when the virtual button is clicked on using a mouse.

12. The system of claim 11, wherein the virtual button initiates the communication with the live operator when the virtual button is clicked on a single time using a mouse.

13. The system of claim 1, wherein the interface is controlled using a remote control device.

14. The system of claim 1, wherein the interface is controlled by a voice of a user.

15. The system of claim 1, wherein the interface is further used to control a video mail application.

16. The system of claim 1, wherein the live operator establishes the packet based videoconference.

17. The system of claim 1, wherein the live operator provides videoconference related assistance.

18. The method for initiating a live operator session in a packet based videoconferencing system, the method comprising:
using an interface provided at an originating endpoint to initiate the live operator session;
wherein the originating endpoint is used to initiate a packet based videoconference with a recipient endpoint.

19. The method of claim 18, wherein the communication with the live operator is a real time communication.

20. The method of claim 18, wherein the interface comprises a virtual button to initiate the communication with the live operator.

21. The method of claim 20, wherein the virtual button initiates the communication with the live operator when the virtual button is clicked on using a mouse.

22. The method of claim 21, wherein the virtual button initiates the communication with the live operator when the virtual button is clicked on a single time using a mouse.

23. The method of claim 18, wherein the interface is controlled using a remote control device.

24. The method of claim 18, wherein the interface is controlled by a voice of a user.

25. The method of claim 18, wherein the interface is further used to control a video mail application.

26. The method of claim 18, wherein the live operator establishes the packet based videoconference.

27. The method of claim 18, wherein the live operator provides videoconference related assistance.

28. A videoconferencing system, comprising:
an originating endpoint; and
a recipient endpoint;
wherein the originating endpoint is used to initiate a packet-based video-communication with the recipient endpoint; and
wherein the originating endpoint comprises an interface to access a video mail application.

29. The videoconferencing system of claim 28, wherein the video mail application comprises real-time video mail data.

30. The system of claim 28, wherein the interface comprises a virtual button to access the video mail application.

31. The system of claim 28, wherein the virtual button initiates the access to the video mail application when the virtual button is clicked on using a mouse.

32. The system of claim 28, wherein the virtual button initiates the access to the video mail application when the virtual button is clicked on a single time using a mouse.

33. The system of claim 28, wherein the interface is controlled using a remote control device.

34. The system of claim 28, wherein the interface is controlled by a voice of a user.

35. The system of claim 28, wherein the interface is further used to control a video mail application.

36. The method for accessing a video mail application in a packet based videoconferencing system, the method comprising:
using an interface provided at an originating endpoint to access a video mail application;
wherein the originating endpoint is used to initiate a packet based video-communication with a recipient endpoint.

37. The method of claim 36, wherein the video mail application comprises real-time video mail data.

38. The method of claim 36, further comprising activating a virtual button of the interface to access the video mail application.

39. The method of claim 36, wherein clicking on the virtual button activates the virtual button.
